(19) United States
(12) Patent Application Publication
(10) Pub. No.: US 2006/0156865 A1
(43) Pub. Date: Jul. 20, 2006

(54) Method of removing the top of a can having a lift off lid

(76) Inventor: Earl A. Weaver, Scottsdale, AZ (US)

Correspondence Address: A W Davis Jr, 6037 W Robin Lane, Glendale, AZ, 85310, US

(21) Appl. No.: 11/373,036

(22) Filed: Mar. 10, 2006

Related U.S. Application Data
(63) Continuation-in-part of application No. 10/245,889, filed on Jan. 29, 2003.

(51) Int. Cl. B67B 7/16

(52) U.S. Cl. 81/3.55

(57) ABSTRACT

A one-piece opener for food and beverage cans which employs a fulcrum type action to rupture the can seal and remove the lid of food cans or opening the drinking aperture of beverage cans. The opener is a one piece molded reinforced handle with a keyed end to hold the key tab of the can while applying an opening force using a fulcrum arm at the rim of the can. The opener is mold injected in one piece, with reinforcing webs along the length, angled sufaces at the midpoint of the handle to provided additional hand and finger contact. A slotted end is provided with a dimension that allows capture of the can key of either food or beverage cans. The opener can be produced in a variety of colors and can accommodate imprinted logos along the sides of the handle.

### CROSS-REFERENCE TO RELATED APPLICATIONS

This application is a continuation-in-part of Ser. No. 10/245,889 for a FLIP TOP CAN OPENER, filed Jan. 29, 2003 by Earl A. Weaver.

### BACKGROUND OF THE INVENTION

Beverage cans have employed pop-top can openers for years. The food industry has recently adopted a similar method to remove the lids from their products. To accomplish this it requires the grasping, bending and twisting of the attached key tab to rupture the opening of a beverage can or breaking the seal of food product to remove the can lid.

The keyed tops are of two types, the ring key used on beverage cans and the fulcrum type used on the new food cans. The ring key is riveted to the top of the can lid and provides a leverage to break a perforated access opening in the can lid. This type of opener poses problems for certain individuals, the key is sometimes difficult to grasp and sometimes can result in broken fingernails. The second type of ring key is a fulcrum type with also requires a key to be leveraged to break the can lid seal. The key is then grasped to pull up on the lid for removal.

This can also be difficult for some users as an amount of effort is required to remove the lid. The same problems of broken nails, along with a chance of spillage is associated with this type of opener.

### BRIEF SUMMARY OF THE INVENTION

The invention relates to openers for the recently introduced food cans with keyed tops along with keyed beverage cans. The opener uses an upward and downward motion using the can as a fulcrum to provide a mechanical advantage to the opening effort.

The opener provides the advantage of opening cans without the chance of broken nails and provides the mechanical advantage to reduce the amount of effort required to remove food can lids and leverage the openings of beverage cans.

### BRIEF DESCRTPTION OF THE DRAWINGS

FIG. 1 is a perspective view.

FIG. 2 is a perspective view.

FIG. 3 is a perspective view.

### DETAILED DESCRIPTION OF THE INVENTION

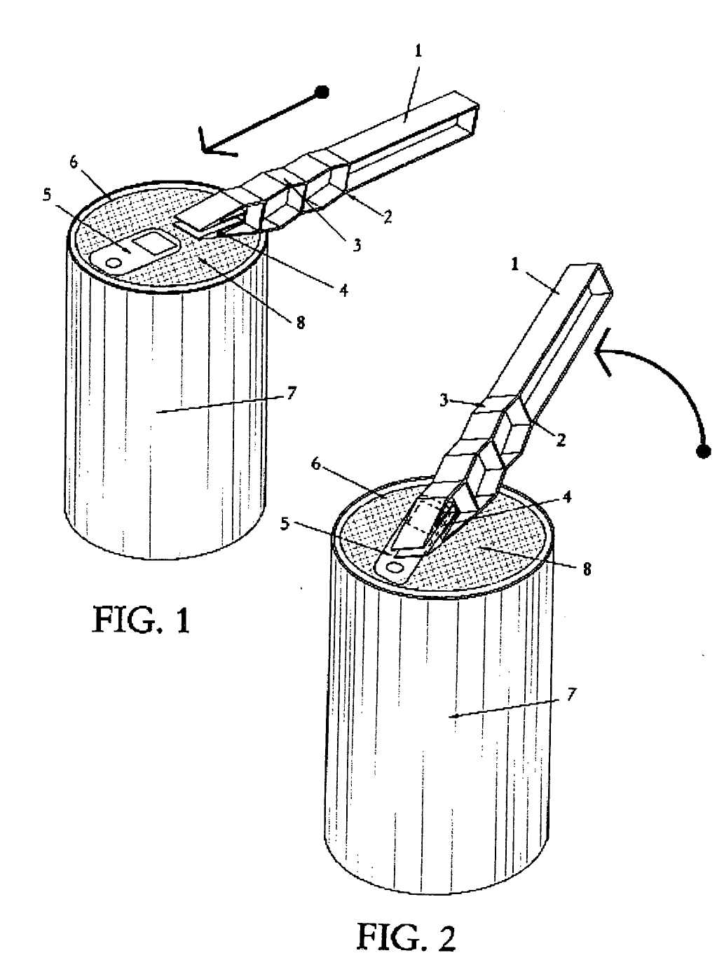

FIG. 1 shows the first step in the method of removing the lift-off can lid 8 of can 7. The lift-off lid 8 has a key tab 5 and a seal 6 which extends around the outside of the lid 8 and can 7. Opener 1 has a slot 4 opposite to the handle end and finger grips 3. The slot 4 can be ½ inches wide and 1½ inches long and tapered to slide under the key tab 5. Opener 1 can be made from plastic with webs 2 formed for strength.

The first step is to position the key tab 5 within the slot 4.

FIG. 2 shows the second step in the method. The second step is to pull up on or lift the opener 1 handle end cause the key tab 5 to break the seal 6.

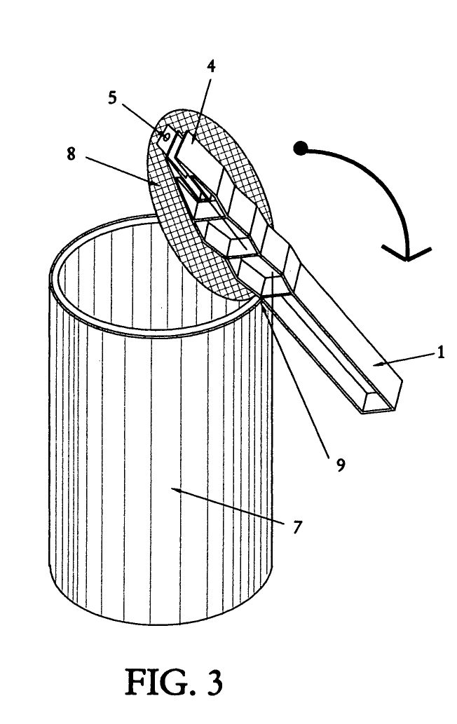

FIG. 3 shows the third step in the method. The third step is to move the handle end down on to the can 7 at a fulcrum point 9 and to keep moving the handle end down until the lid can be removed.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

1. A method of opening a can having a lift-off lid, the lid having a key tab which is used to perforate a seal on the lid, the seal on the lid extends around the outside of the lid and the can, comprising the following steps,
providing an opener, the opener having a slot opposite to a handle end,
placing the key tab within the slot,
moving the opener in an upward direction to cause the key tab to break the seal,
moving the opener downwardly onto the can until the lid can be removed.
